(19) United States
(12) Patent Application Publication
(10) Pub. No.: US 2014/0181430 A1
(43) Pub. Date: Jun. 26, 2014

(54) EQUALIZING WEAR ON STORAGE DEVICES THROUGH FILE SYSTEM CONTROLS

(71) Applicant: UNISYS CORPORATION, Blue Bell, PA (US)

(72) Inventors: Kelsey Bruso, Roseville, MN (US); James McBreen, Roseville, MN (US)

(73) Assignee: Unisys Corporation, Blue Bell, PA (US)

(21) Appl. No.: 13/726,675

(22) Filed: Dec. 26, 2012

(51) Int. Cl. G06F 12/00

(52) U.S. Cl. CPC G06F 12/00
USPC 711/156

(57) ABSTRACT

Data stored in file blocks and storage blocks of a storage device may be tracked by the file system. The file system may track a number of writes performed to each file block and storage block. The file system may also track a state of each storage block. The file system may use information, such as the write count and the block state, to determine locations for updated data to be stored on the storage device. Placement of data by the file system allows the file system to manage wear on storage devices, such as solid state storage devices.

### FIELD OF THE DISCLOSURE

The instant disclosure relates to data storage. More specifically, this disclosure relates to storing data in solid state devices.

### BACKGROUND

Solid state devices (SSDs) are replacing hard disk drives (HDDs) for consumer and enterprise data storage needs. SSDs include large banks of flash memory, based on semiconductor transistors, to store data, rather than the magnetic platters of HDDs. One challenge of solid state storage devices is maintaining the reliability of the device as data writes are performed to the same area of storage. SSDs have limited life spans due to damage sustained during electron tunneling in the semiconductor devices. First-generation SSDs use single-level cell (SLC) flash, in which each flash cell stores a single bit value. This variant of flash has relatively high endurance limits—around 100,000 erase cycles per block—but increases costs of the SSD, because the storage density is lower.

Newer generation SSDs use multi-level cell (MLC) technology, in which each flash cell stores a multiple bit value. MLCs increase the storage density of SSDs, and thus reduce the cost per bit of an SSD. However, MLC SSDs have lower endurance than SLC SSDs. During an erase in an SSD, an entire block of flash cells must be erased, which increases the rate of damage to the SSD. Each erasure makes the device less reliable, increasing the bit error rate (BER) observed by accesses. Consequently, SSD manufacturers specify not only a maximum BER (usually between 10⁻¹⁴ to 10⁻¹⁵, as with conventional hard disks), but also a limit on the number of erasures within which this BER guarantee holds. For MLC devices, the rated erasure limit is typically 5,000 to 10,000 cycles per block. As a result, a write-intensive workload can wear out the SSD within months. Consequently, the reliability of MLC devices remains a paramount concern for its adoption in servers.

File systems generally allocate file data onto storage devices in even size chunks, referred to as “blocks.” Each block typically consumes the same amount of space, for example 8,000 bytes (8K bytes). FIG. 1 is a block diagram illustrating a conventional file system 100.

At the left, a directory 102 links together a name for the file and the corresponding inode structure 104, which manages the contents of the file. The inode 104 points to blocks 106a-n, 108, and 112 on a storage device. The blocks may hold data or links to other index structures. The file system creates only the number of blocks required to hold the file contents. The direct blocks 106a-n, 108, and 112, indirect blocks 110a-n, 114a-n, and doubly indirect blocks 116a-n identify the areas on the storage device that hold the file data. When the size of a file block differs from the size of a storage block, the file system may maintain more control information about the relationship between a file block and its corresponding storage block or blocks. In this generic file system, no provision is made to count the number of times a block is rewritten. The system simply reuses the block or allocates a new block containing the updated data and writes its data to the disk.

Because blocks of an SSD may wear at different rates, portions of the SSD may become unusable before other portions of the SSD. Thus, the SSD may require replacement, despite certain portions of the SSD having functional capacity. Some prior solutions to prevent uneven wear of an SSD include: flash care schemes, adaptive flash care management, endurance management, and wear leveling. However, these techniques operate independently of the file system and rely on guesses about the read and write behavior of application accesses to data. Furthermore, these techniques are embedded in the controller for a specific storage device, and thus can only affect the read and write behavior of a single device, based on the immediate request or the last few requests.

### SUMMARY

Portions of an SSD, such as storage blocks, may be tracked over the life of the SSD to identify portions that have been heavily written. When the number of writes exceeds a threshold, the contents of that portion of the SSD may be moved to a different portion of the SSD. The worn portion of the SSD may then be filled with data contents that are less frequently updated. Thus, the SSD may remain in use for a longer before being replaced. Data regarding the SSD, such as write counts, may be stored by the file system.

In certain embodiments, SSD life may be improved by migrating less frequently written, as well as read-only file blocks, to SSD blocks that are approaching the limit of their write life cycle.

In other embodiments, I/O performance of SSD devices may be optimized to improve write performance by issuing write instructions to devices that have the highest currently available bandwidth and delaying erase instructions on the devices with less available bandwidth until these devices have bandwidth to complete an erase instruction without significant impact to either read or write operations. Furthermore, concurrent partial writes of several blocks may be aggregated to a single write to a single block.

According to one embodiment, a method includes writing data to a file block in a file system. The method also includes incrementing a write counter associated with the file block.

According to another embodiment, a computer program product includes a non-transitory computer-readable medium having code to write data to a file block in a file system. The medium also includes code to increment a write counter associated with the file block.

According to yet another embodiment, an apparatus includes a memory, a storage device, and a processor coupled to the memory and the storage device. The processor is configured to write data to a file block in a file system. The processor is also configured to increment a write counter associated with the file block.

According to one embodiment, a method includes receiving first data. The method also includes determining a first storage block on a first storage device of a plurality of storage devices for storing the first data. The method further includes writing the first data to the first storage block of a first storage device. The method also includes incrementing a first counter associated with the first storage block.

According to another embodiment, a computer program product includes a non-transitory computer-readable medium having code to receive first data. The medium also includes code to determine a first storage block on a first storage device of a plurality of storage devices for storing the first data. The medium further includes code to write the first data to the first storage block of a first storage device. The medium also includes code to increment a first counter associated with the first storage block.

According to yet another embodiment, an apparatus includes a memory, a plurality of storage devices, and a processor coupled to the memory and the plurality of storage devices. The processor is configured to receive first data. The processor is also configured to determine a first storage block on a first storage device of the plurality of storage devices for storing the first data. The processor is further configured to write the first data to the first storage block of the first storage device. The processor is also configured to increment a first counter associated with the first storage block.

According to one embodiment, a method includes setting a disk policy for a plurality of storage devices, the disk policy specifying a replacement cycle for the plurality of storage devices. The method also includes writing first data to a first storage block on a first storage device of the plurality of storage devices based, in part, on the disk policy.

According to another embodiment, a computer program product includes a non-transitory computer-readable medium having code to set a disk policy for a plurality of storage devices, the disk policy specifying a replacement cycle for the plurality of storage devices. The medium also includes code to write first data to a first storage block on a first storage device of the plurality of storage devices based, in part, on the disk policy.

According to yet another embodiment, an apparatus includes a memory, a plurality of storage devices, and a processor coupled to the memory and the plurality of storage devices. The processor is configured to set a disk policy for a plurality of storage devices, the disk policy specifying a replacement cycle for the plurality of storage devices. The processor is also configured to write first data to a first storage block on a first storage device of the plurality of storage devices based, in part, on the disk policy.

According to one embodiment, a method includes receiving first data corresponding to an update of at least one file block. The method may further include identifying, by the file system, a storage block corresponding to the at least one file block. The method also includes writing the first data to a first storage block of a storage device.

According to another embodiment, a computer program product includes a non-transitory computer-readable medium having code to receive first data corresponding to an update of at least one file block. The medium also includes code to identify, by the file system, a storage block corresponding to the at least one file block. The medium further includes code to write the first data to a first storage block of a storage device.

According to yet another embodiment, an apparatus includes a memory, a plurality of storage devices, and a processor coupled to the memory and the plurality of storage devices. The processor is configured to receive first data corresponding to an update of at least one file block. The processor is also configured to identify, by the file system, a storage block corresponding to the at least one file block. The processor is further configured to write the first data to a first storage block of a storage device.

According to one embodiment, a method includes receiving a write request to update data on a first storage block of a first storage device. The method also includes determining the first storage device is not available. The method further includes performing the write request on a second storage block of a second storage device.

According to another embodiment, a computer program product includes a non-transitory computer-readable medium having code to receive a write request to update data on a first storage block of a first storage device. The medium also includes code to determine the first storage device is not available. The medium further includes code to perform the write request on a second storage block of a second storage device.

According to yet another embodiment, an apparatus includes a memory, a plurality of storage devices including a first storage device and a second storage device, and a processor coupled to the memory and the plurality of storage devices. The processor is configured to receive a write request to update data on a first storage block of a first storage device. The processor is also configured to determine the first storage device is not available. The processor is further configured to perform the write request on a second storage block of a second storage device.

According to one embodiment, a method includes receiving a write request to update data on a first storage block of a first storage device when the first storage device is mirrored by a second storage device. The method also includes writing the data to the first storage block of the first storage device. The method further includes identifying a mirrored copy of the data on a second storage block of a second storage device. The method also includes writing the data to the second storage block of the second storage device.

According to another embodiment, a computer program product includes a non-transitory computer-readable medium having code to receive a write request to update data on a first storage block of a first storage device when the first storage device is mirrored by a second storage device. The medium also includes code to write the data to the first storage block of the first storage device. The medium further includes code to identify a mirrored copy of the data on a second storage block of a second storage device. The medium also includes code to write the data to the second storage block of the second storage device.

According to yet another embodiment, an apparatus includes a memory, a plurality of storage devices including a first storage device and a second storage device, and a processor coupled to the memory and the plurality of storage devices. The processor is configured to receive a write request to update data on a first storage block of a first storage device when the first storage device is mirrored by a second storage device. The processor is also configured to write the data to the first storage block of the first storage device. The processor is further configured to identify a mirrored copy of the data on a second storage block of a second storage device. The processor is also configured to write the data to the second storage block of the second storage device.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating a conventional file system.

FIG. 2 is a block diagram illustrating an exemplary file system according to one embodiment of the disclosure.

FIG. 3 is a flow chart illustrating a method for counting writes to file system blocks according to one embodiment of the disclosure.

FIG. 4 is a block diagram illustrating a storage block bit map for tracking availability according to one embodiment of the disclosure.

FIG. 5 is a block diagram illustrating a storage block bit map for tracking a number of writes to a storage block according to one embodiment of the disclosure.

FIG. 6 is a block diagram illustrating a mapping of file blocks into storage blocks according to one embodiment of the disclosure.

FIG. 7 is a flow chart illustrating a method of selecting storage blocks from multiple disk drives for write operations according to one embodiment of the disclosure.

FIG. 8 is a block diagram illustrating a write count bit map for an array of storage devices according to one embodiment of the disclosure.

FIG. 9 is a block diagram illustrating an array of storage devices having administrator-defined policies according to one embodiment of the disclosure.

FIG. 10 is a flow chart illustrating a method of selecting a storage device for write operations based on administrator-defined policies according to one embodiment of the disclosure.

FIG. 11 is a block diagram illustrating consolidation of file block writes to a single storage block write according to one embodiment of the disclosure.

FIG. 12 is a block diagram illustrating a partial update of a file block in a storage block according to one embodiment of the disclosure.

FIG. 13 is a block diagram illustrating combined full and partial update of file blocks in a storage block according to one embodiment of the disclosure.

FIG. 14 is a flow chart illustrating a method of selecting storage blocks for writing by the file system according to one embodiment of the disclosure.

FIG. 15 is a state diagram illustrating states for a storage block according to one embodiment of the disclosure.

FIG. 16 is a block diagram illustrating a file block to storage block mapping before a write operation according to one embodiment of the disclosure.

FIG. 17 is a block diagram illustrating a file block to storage block mapping after a write operation according to one embodiment of the disclosure.

FIG. 18 is a flow chart illustrating a method of writing data based on storage block states according to one embodiment of the disclosure.

FIG. 19 is a flow chart illustrating management of mirrored drives by a file system according to one embodiment of the disclosure.

FIG. 20 is a block diagram illustrating a computer network according to one embodiment of the disclosure.

FIG. 21 is a block diagram illustrating a computer system according to one embodiment of the disclosure.

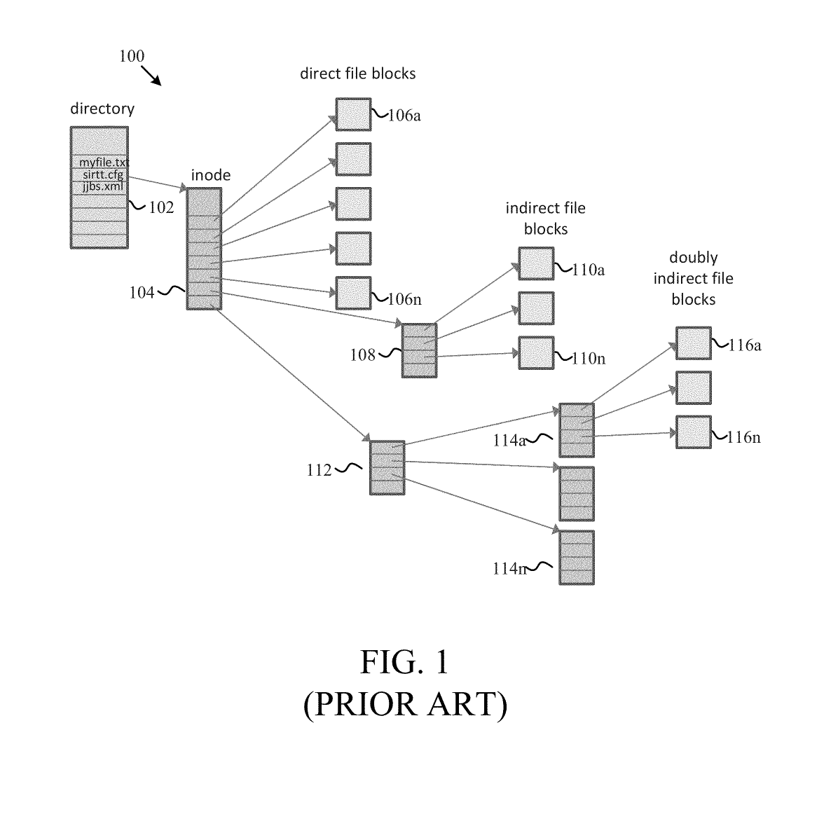

### DETAILED DESCRIPTION

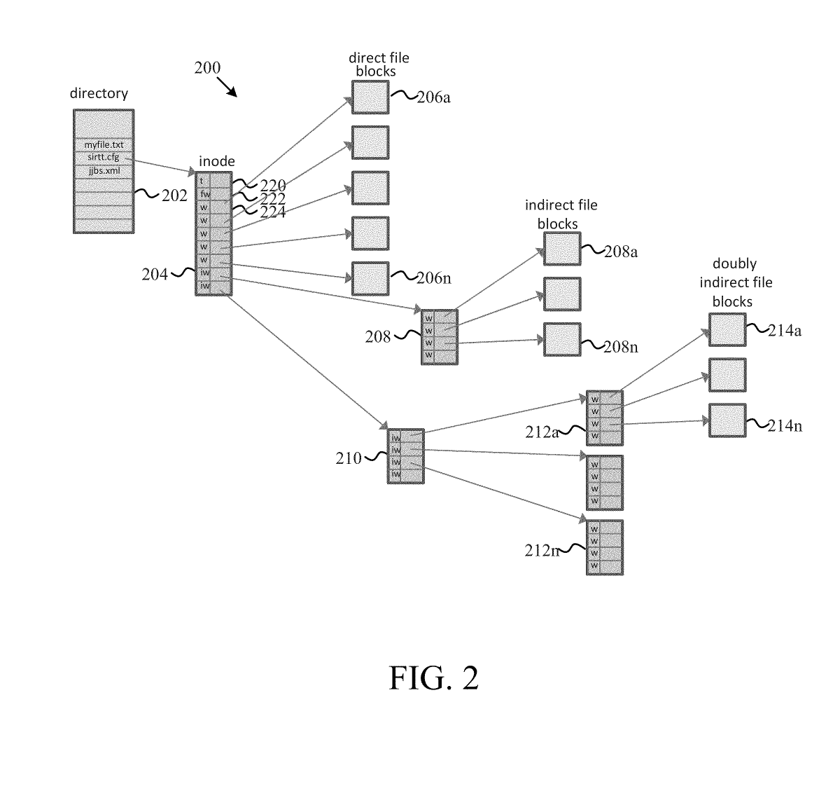

A counter may be implemented in a file system for tracking the number of times a file block is written. FIG. 2 is a block diagram illustrating an exemplary file system according to one embodiment of the disclosure. In one embodiment, an inode 204, or subsidiary index structure, of a directory 202 may store the count. In another embodiment, the count may be aggregated to a top level of the inode 204. The inode 204 may link to direct file blocks 206a-n, 208, 210, indirect file blocks 208a-n and 212a-n, and doubly-indirect file blocks 214a-n. Each of the direct file blocks 208 and 210 linking to indirect file blocks 208a-n and 212a-n may also store counters corresponding to the linked indirect file blocks.

The inode 204 may include a write count 224 for each file block indicated by a ‘w.’ The inode 204 may also include a summation 222 of all block writes for a file indicated by ‘fw.’ The ‘fw’ may be calculated by summing the counters corresponding to each file block containing data from the file. The inode 204 may further include a summation for the write counts for the blocks controlled by the subsidiary index structures indicated by ‘iw.’ The values for ‘f’ and ‘iw’ may be calculated on demand by examining at all the ‘w’ values in the indexing structures. Alternatively, the ‘fw’ and ‘iw’ counters may be incremented along with the ‘w’ counters upon a write request. The inode 204 may also store a timestamp 220 for the last block write that has occurred in the file indicated by ‘t.’

The file system counters 220, 222, and 224, may count the number of times a block is rewritten. Thus, a value of 0 means the block was written only once. Alternatively, the file system counters 220, 222, and 224, may count the number of times a block is written. Thus, a value of 1 means the block was written only once.

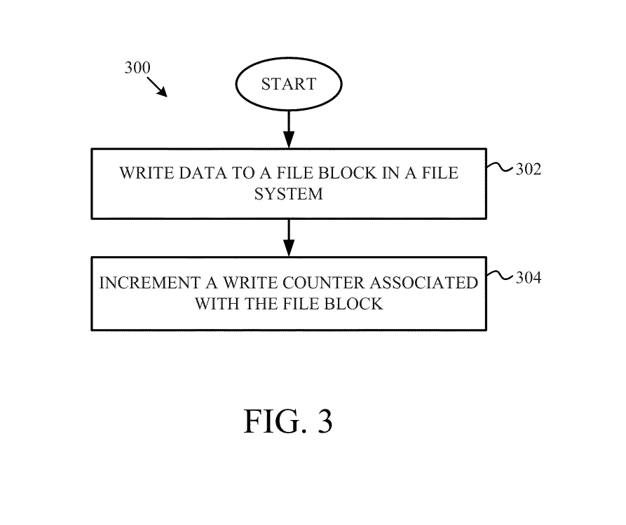

FIG. 3 is a flow chart illustrating a method for counting writes to file system blocks according to one embodiment of the disclosure. A method 300 may begin at block 302 with writing data to a file block in a file system. For example, a request to write the data may be received by an operating system from an application. Then, at block 304 a write counter associated with the file block may be incremented. The write counter of block 304 may be tracked by the operating system in the file system for the storage device containing the data. That file system may be recorded in an allocation table of the storage device.

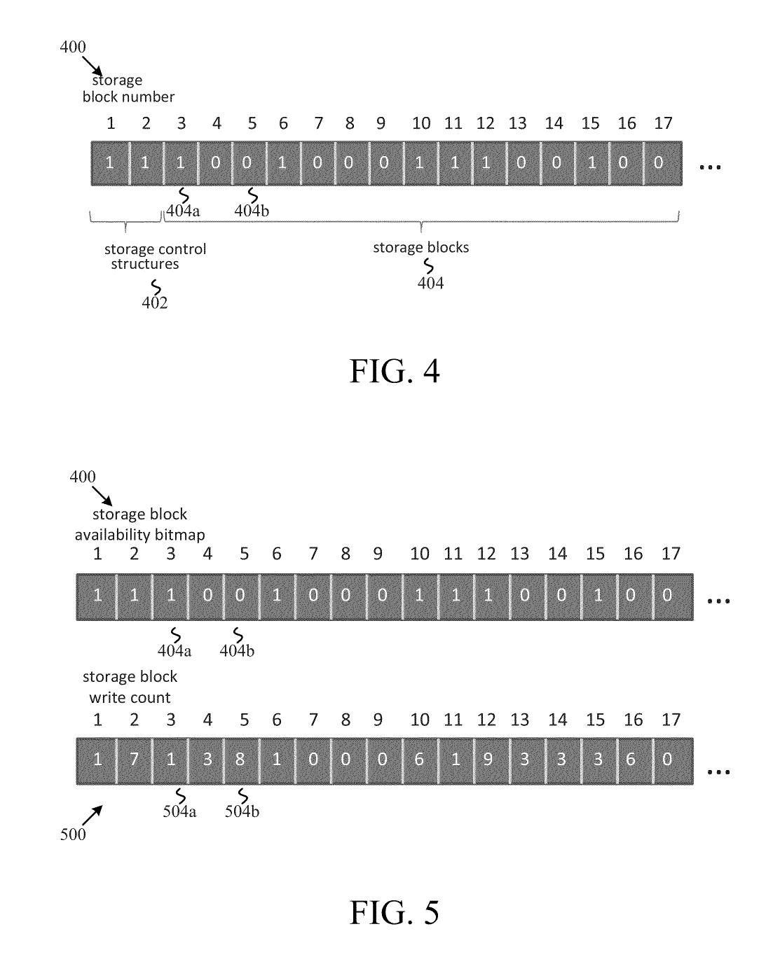

The file system may also manage storage device space by tracking whether space on a storage device is used or available. FIG. 4 is a block diagram illustrating a storage block bit map for tracking availability according to one embodiment of the disclosure. A bit map 400 may include a first portion 402 for storing storage control structures and a second portion 404 for storing information about storage blocks. The first portion 402 may include, for example, control information about the storage device including the storage identifier (name) and a copy of the bit map itself. In one embodiment, the availability data is stored in an availability bit map. In another embodiment, flags or another mechanism is used instead of a bit map.

When the file system allocates a block from the storage device to write file data, the file system may read the bit map, identify a block whose bit is set to 0, indicating it is available for use, then set that bit to 1, store the bit map, and write the file data to that storage block. For example, a storage block corresponding to bit 404a may be available for writes, while a storage block corresponding to bit 404b may not be available for writes. Although 1's and 0's are disclosed in the examples, the values may be reversed.

File Systems may use a single bit map or multiple bit maps. For example, a second bit map may be stored indicating a count of write operations executed on a storage block. FIG. 5 is a block diagram illustrating a storage block bitmap for tracking a number of writes to a storage block according to one embodiment of the disclosure. A storage block bit map 500 is illustrated next to the availability bit map 400. The counts in the storage block bit map 500 indicate the number of write operations completed in corresponding storage blocks. For example, a storage block corresponding to counter 504a was written one time and is available according to bit 404a. In another example, a storage block corresponding to counter 504b was written eight times and is not available according to bit 404b.

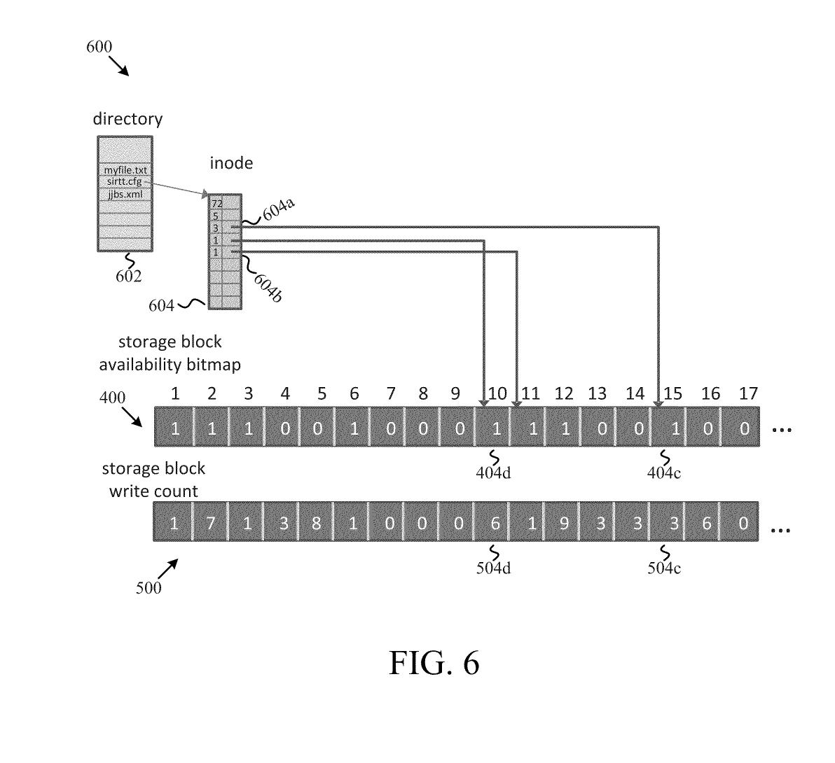

Files may be divided into file blocks for storage on a storage device as illustrated above with reference to FIG. 2. The file blocks may be mapped to storage blocks on the storage device. FIG. 6 is a block diagram illustrating a mapping of file blocks into storage blocks according to one embodiment of the disclosure. A mapping 600 of file blocks listed in an inode 604 for one file of a directory 602 is shown in FIG. 6. For example, a file block corresponding to entry 604a in the inode 604 may be stored in a storage block corresponding to the availability bit 404c and the write count 504c. In another example, a file block corresponding to entry 604b in the inode 604 may be stored in a storage block corresponding to the availability bit 404d and the write count 504d. File block counters and storage block counters may be stored within the file system and updated simultaneously when data is written to the file block and the storage block.

Tracking a number of writes to blocks can be used to prolong the useful life of storage devices, such as SSDs or similar devices, when the reliability of the device declines as the number of writes to an area of the device increases. For example, when the file system is to write a storage block, the file system may check to see if the storage block write count would exceed a threshold value. If so, then the file system may find an alternate storage block for the write operation. That is, the data to be written may be written to a block identified to have a lesser amount of wear. In another example, the file system may examine the file directory and the inode update counts to identify a block in a file that is less frequently updated, such as a read-only file. If that storage block's write count is below a second threshold, the file system moves the data from the storage block with the low write count to the storage block with the high write count. That is, data that is less frequently updated may be moved on the storage device from storage blocks with low write counts to storage blocks with high write counts.

Over time, storage blocks with a high write count become populated with less frequently updated data and are infrequently or never written again. The blocks may continue to be read as many times as necessary, because the reads may have only a minimal effect on reliability of the storage device. This allows the device to remain in service for a longer time, maximizing a customer's investment in storage devices, such as SSDs.

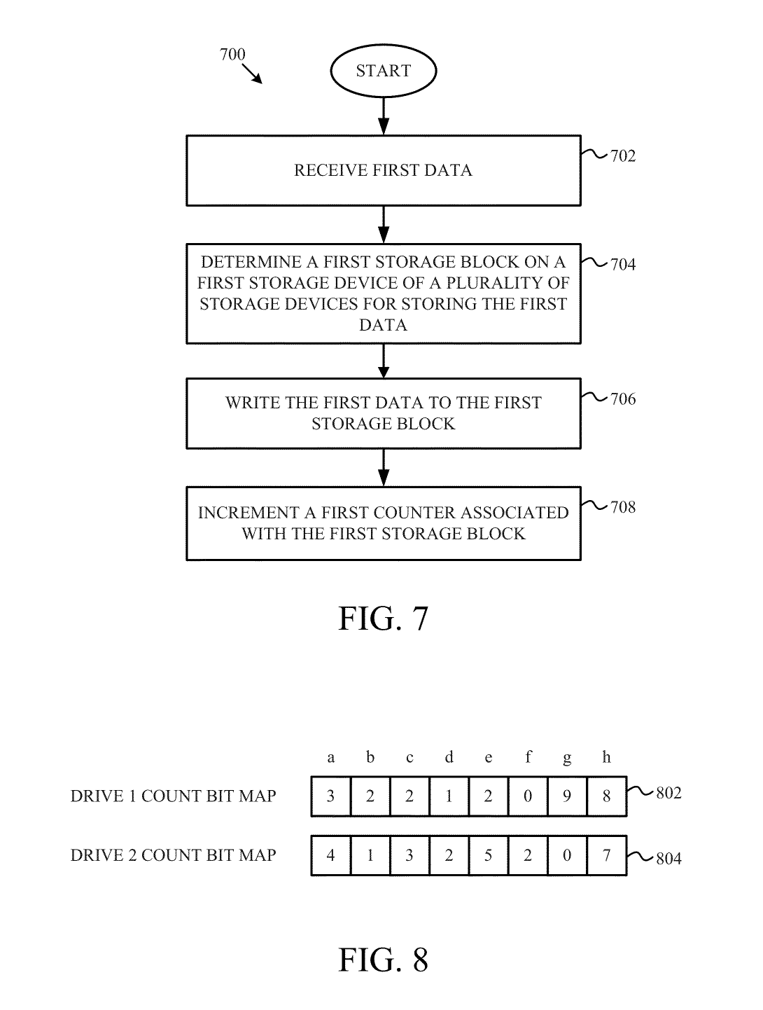

FIG. 7 is a flow chart illustrating a method of selecting storage blocks for write operations according to one embodiment of the disclosure. A method 700 begins at block 702 with receiving first data. At block 704, a first storage block on a first storage device is identified for storing the first data. A storage block may be identified based, in part, on the characteristics of the first data (e.g., likelihood of being frequently updated), availability of storage blocks on the storage device, and/or write counts of the storage blocks on the storage device. The storage block selection at block 704 may be determined by the file system. At block 706, the first data is written to the first storage block. At block 708, a first counter associated with the first storage block is incremented.

The method 700 of FIG. 7 may be extended to operate on a plurality of storage devices. For example, with a set of storage devices, wear may be more effectively spread through the devices. That is, by spreading more frequently rewritten blocks across a set of devices, the useful life of the entire set of devices may be extended.

FIG. 8 is a block diagram illustrating a write count bit map for an array of storage devices according to one embodiment of the disclosure. A first bit map corresponding to a first storage device of a plurality of storage devices is shown in bit map 802. A second bit map corresponding to a second storage device of a plurality of storage devices is shown in bit map 804. When data that may be frequently rewritten is to be stored within the plurality of storage devices, storage blocks with low write counts may be identified for storage. For example, blocks d and f of bit map 802 and blocks b and g of bit map 804 may be identified as potential locations for storing frequently rewritten data. If these blocks are already occupied by data, but the stored data is less frequently rewritten, then the data in these blocks may be moved to storage blocks with high write counts. Then, the more frequently rewritten data may be stored in these blocks having low write counts.

Another technique for managing a plurality of storage devices may include managing wear on a set of solid state storage devices through administrator-defined policies. Computer data center managers may be faced with a tradeoff among several competing priorities including maximizing the system availability while replacing storage devices that are worn out, minimizing the recurring costs for the system which includes keeping solid state storage devices in use as long as possible, keeping the system's componentry up-to-date which includes replacing aging storage devices, and avoiding unpredictability for incurring expense which includes replacing a storage device which wears out unexpectedly.

Wear policies may be policy-driven to ease system administration. For example, a data center may have, for example, eighty storage devices, and an administrator may desire to enforce a policy of replacing one storage device per month on the first of the month. With this policy, the data center would replace the entire set of storage devices over approximately seven years. To enforce this policy, the file system may take into account this policy when identifying storage blocks for storing data. In particular, the file system may determine when the next storage device is scheduled for replacement using several criteria including a threshold for maximum write count before degradation occurs, measured as an aggregate of the write counts across all its blocks, a total uptime for a storage device, and/or other criteria specified by the system administrator. If a device is scheduled for replacement, the storage blocks of that device may be prohibited from storing data.

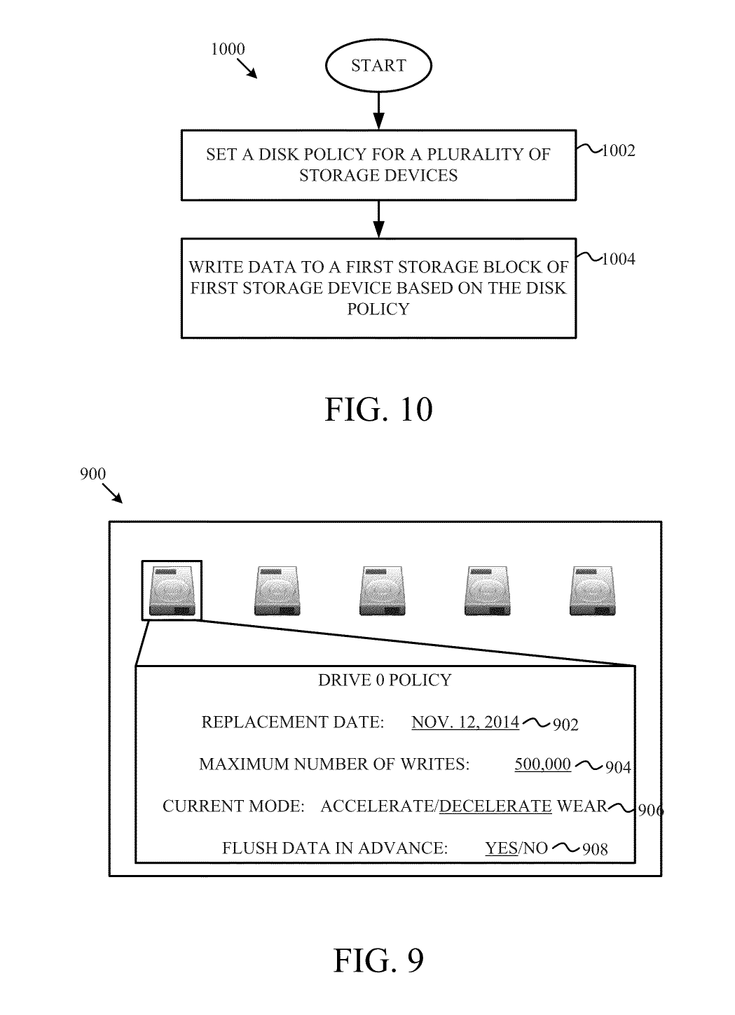

FIG. 9 is a block diagram illustrating an array of storage devices having administrator-defined policies according to one embodiment of the disclosure. A policy 900 may specify criteria for a plurality of storage devices. The policy 900 may include a replacement date 902 for each drive, a maximum number 904 of writes for each drive, a current mode 906 (e.g., whether to accelerate or decelerate wear of the storage device), and/or a setting 908 whether to flush data in advance of replacement. A policy may be specific to all of the storage devices, a group of the storage devices, and/or an individual storage device. Based on the setting 906, over a period of time, the file system can direct write operations to decelerate the wear on the next storage device scheduled for replacement in order to prolong its useful life, or to accelerate the wear such that on the date when it is scheduled to be replaced, it is worn out, that is, the write count for each storage block exceeds the reliability threshold.

Along with the acceleration/deceleration mechanism, the file system may also flush data from a storage device and, based on the write counts and their timing, move blocks appropriately in order to preserve the data. Thus, on the date when the storage device is scheduled to be replaced, the storage device may have little or no data stored on it.

The policy-driven storage devices may be implemented through a prohibited bit map, similar to the bit maps of FIGS. 4-5. The prohibited bit map may have a bit corresponding to each storage block of the storage device. The value of the bit map may indicate to the file system whether data can be stored in the storage block. For example, a ‘1’ bit may indicate the storage block is not available for data and a ‘0’ bit may indicate the storage block is available for data. During the end of a storage device's lifetime, the storage blocks may be marked as prohibited to allow data to be flushed from the storage device in advance of replacement. In one embodiment, the prohibition control structure is combined with the storage block availability bit map. In another embodiment, flags or another mechanism is used instead of a bit map.

FIG. 10 is a flow chart illustrating a method of selecting a storage device for write operations based on administrator-defined policies according to one embodiment of the disclosure. A method 1000 begins at block 1002 with setting a disk policy for a plurality of storage devices. The method 1000 continues to block 1004 with writing data to a first storage block of the first storage device based on the disk policy.

Wear on storage devices may be reduced by minimizing the number of write operations performed on the storage blocks. The reduction of write operations performed on a storage device may be particularly advantageous for SSDs, because an entire storage block of an SSD is written with each write request. Even if the write request is for only a portion of the storage block, the entire storage block is written. That is, if the write request is for only a portion of the storage block, a device driver reads the entire block into memory, updates the block with the data from the write request, and writes the storage block back to the storage.

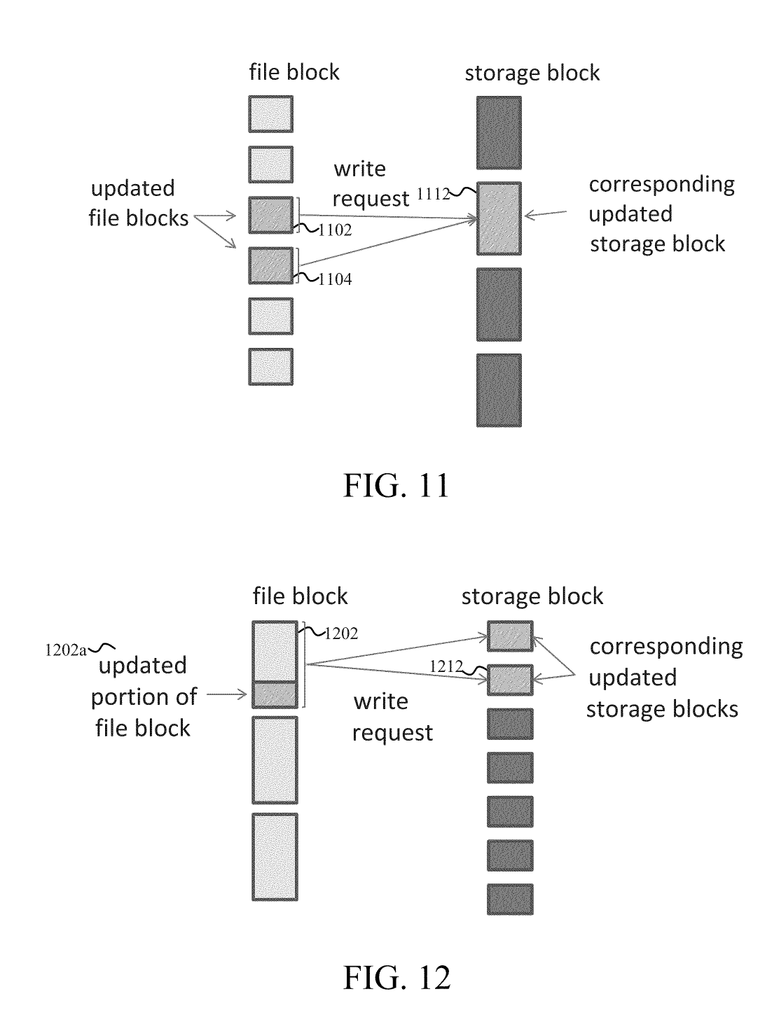

In the case that the file blocks are smaller than the storage blocks, multiple file block writes may be combined into a single storage block write as shown in FIG. 11. FIG. 11 is a block diagram illustrating consolidation of file block writes to a single storage block write according to one embodiment of the disclosure. Conventionally, a write to file block 1102 would result in a write to storage block 1112, and a subsequent write to file block 1104 would result in a second write to storage block 1112. The two write operations may be combined into a single write operation on the storage block 1112, such that wear on the storage block 1112 is reduced. When the file system does not immediately know that two adjacent file blocks are updated, the file system may delay the first write to detect the update of an adjacent block. The file system may then combine the write requests into a single write request.

Combining write requests to storage blocks reduces the wear on a specific storage block by eliminating the second rewrite of the entire storage block, thus prolonging the useful life of the storage block. Furthermore, the combination of write requests increases overall storage throughput by reducing two write requests to one write request. Additionally, the combined write requests increase storage throughput by eliminating two read-before-write cycles when processing write requests for adjacent blocks. Although immediately adjacent blocks are illustrated in FIG. 11, the adjacent blocks may include any two or more file blocks mapped to the same storage block.

In the case that file blocks are larger than the storage blocks, a conventional file system may write an entire file block onto the corresponding set of storage blocks, using as many storage blocks as required to contain the file block. Instead, a partial update may be performed to update only storage blocks corresponding to a portion of the file block. The file system may write only the updated portion of the file block onto the corresponding storage block or blocks. FIG. 12 is a block diagram illustrating a partial update of a file block in a storage block according to one embodiment of the disclosure. When a portion 1202a of a file block 1202 is updated, the storage block 1212 storing the portion 1202a may be updated.

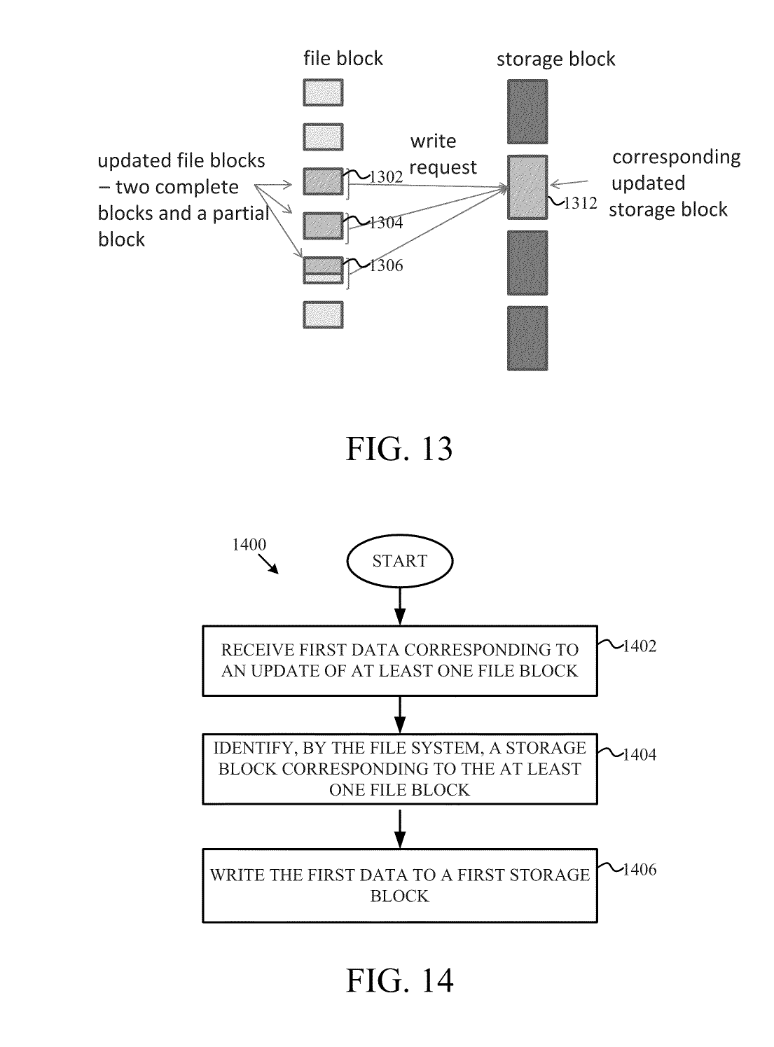

The write processes of FIGS. 11 and 12 may be combined as illustrated in FIG. 13. FIG. 13 is a block diagram illustrating combined full and partial update of file blocks in a storage block according to one embodiment of the disclosure. Two file blocks 1302, 1304 and a portion of file block 1306 may be updated in corresponding storage block 1312 in a single write request. The combined write request may include a combination of write requests for blocks 1302 and 1304, such as illustrated in FIG. 11, and a partial update of file block 1306, such as illustrated in FIG. 12. By tracking partial block updates as well as complete block updates, the file system may combine the updates into a single write request to the storage device.

FIG. 14 is a flow chart illustrating a method of selecting storage blocks for writing by the file system according to one embodiment of the disclosure. A method 1400 begins at block 1402 with receiving first data corresponding to an update of at least one file block. At block 1404, the file system identifies a storage block corresponding to the at least one file block. The corresponding storage block may be a storage block corresponding to two or more file blocks updated in block 1402. The corresponding storage block may also be a storage block corresponding to a portion of a file block updated in block 1402. At block 1406, the first data is written to the first storage block.

Throughput may be further optimized on storage devices, such as SSDs, by separating the erase cycle from a write request. As described above, SSD write requests are completed by a first erase cycle to clear existing data from a storage block and a second write cycle to write new data to the storage block. Conventionally, when the write requests are managed exclusively by the storage device driver, the driver combines the erase cycle and the write cycle into a single operation. Instead, file system information may be incorporated into the processing and the erase cycle and the write cycle may be separated into independent activities. When multiple storage devices are employed to store file data, the file system may balance write requests among the storage devices. By diverting certain operations away from busy storage devices and to available storage devices, the throughput of the storage system may be improved. To manage the erase and write cycles independently, the file system may store state information for each storage block of the storage devices.

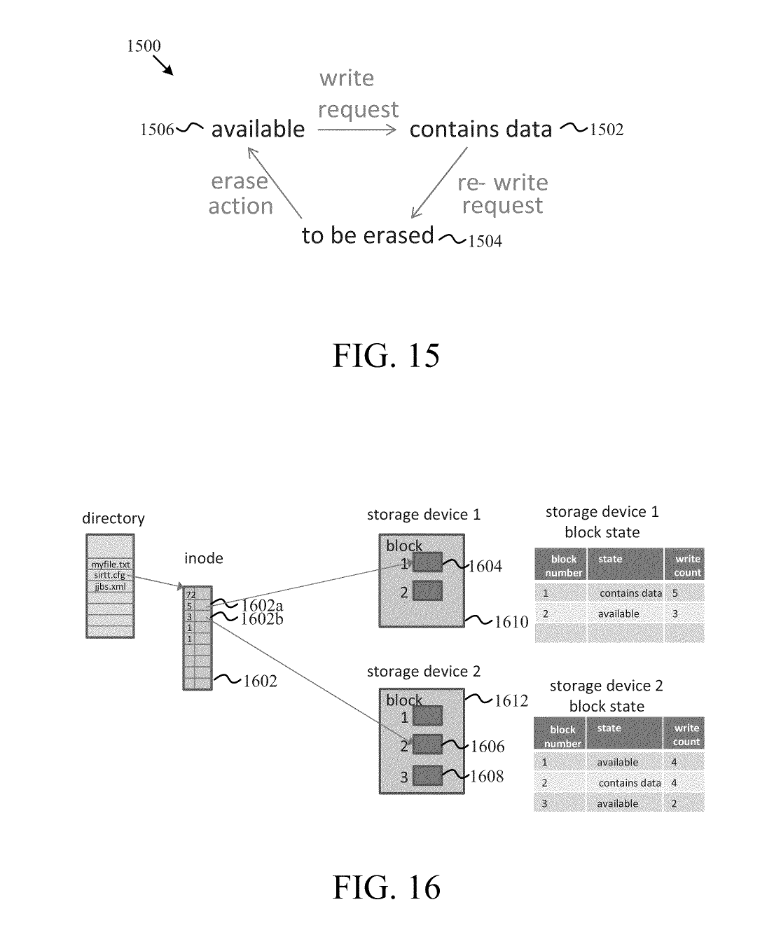

FIG. 15 is a state diagram illustrating states for a storage block according to one embodiment of the disclosure. A state diagram 1500 may include a state 1502 indicating the storage block contains data. The storage block may transition from the state 1502 to a state 1504 when a re-write request is received. At the state 1504, the block is identified as ready for erasure. The storage block may transition from the state 1504 to a state 1506 when an erase action is completed. At the state 1506, the block is identified as available for writing. The storage block may transition from the state 1506 to the state 1502 when a write request is received.

When a storage device is added into a system, every storage block may be marked as “available.” When data is written to the storage block via a write request, the storage block's state is changed to “contains data.” When a second write request for the storage block is received, the storage block's state changes to “to be erased.” After an erase action occurs, the storage block is returned to the “available” state.

The state information may be used to assign write operations to storage devices to improve throughput. FIG. 16 is a block diagram illustrating a file block to storage block mapping before a write operation according to one embodiment of the disclosure. An inode 1602 may be associated with storage blocks 1604 and 1606. The file block 1602a may have data stored in storage block 1604 of storage device 1610 (e.g., storage device 1, block 1). The file block 1602b may have data stored in storage block 1606 of storage device 1612 (e.g., storage device 2, block 2). Other inode entries may have data stored in other storage blocks on the same or other storage devices (not shown).

When a user updates the file block 1602a, the file system will attempt to write the updated data onto the storage device 1610. If the storage device 1610 is busy servicing other read and write requests from the file system and the storage device 1612 is not busy, the file system may choose the storage device 1612 for completing the write request.

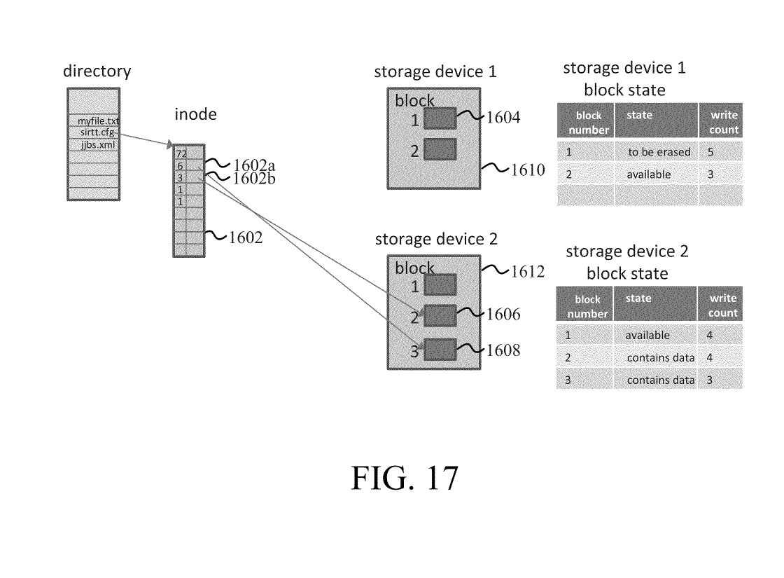

The file system may identify storage block 1608 (e.g., storage block 3 on storage device 2) as available to store the updated data associated with the file block 1602a. The file system may send a write request to the storage device 1612, update the write count in the inode from 5 to 6, set the block state for storage block 1608 from “available” to “contains data,” increase a write count for the storage block 1608 from 2 to 3, and set the block state for storage block 1604 from “contains data” to “to be erased.” FIG. 17 is a block diagram illustrating a file block to storage block mapping after a write operation according to one embodiment of the disclosure.

The file system or storage device driver may periodically examine state information for the storage blocks of a storage device. For each block having a state of “to be erased,” the file system or driver may issue a request to the storage device to erase the block and then change the state from “to be erased” to “available.”

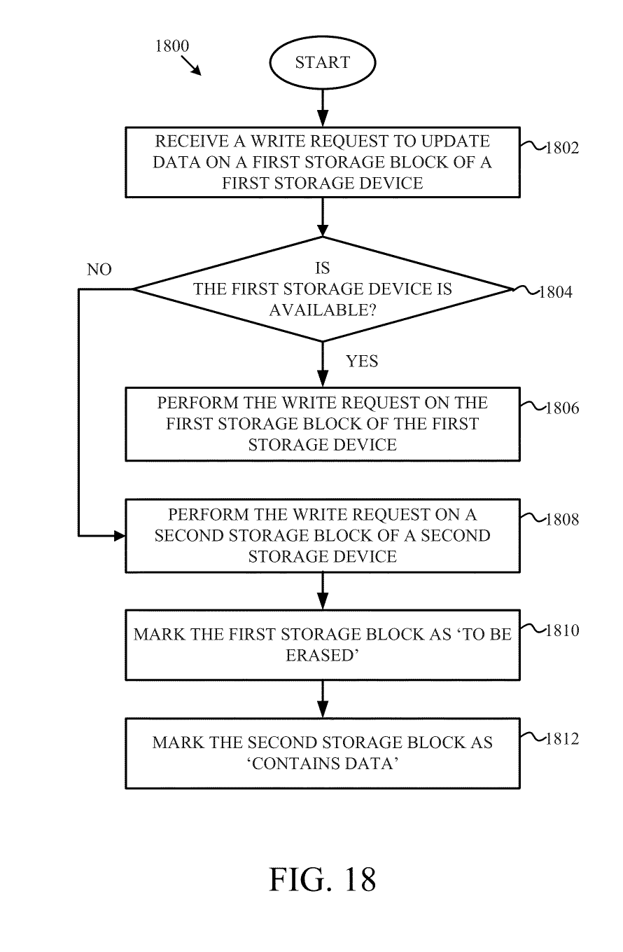

FIG. 18 is a flow chart illustrating a method of writing data based on storage block states according to one embodiment of the disclosure. A method 1800 begins at block 1802 with receiving a write request to update data on a first storage block of a first storage device. At block 1804, it is determined whether the first storage device is available. If available, the method 1800 proceeds to block 1806 to perform the write request on the first storage block of the first storage device. If the first storage device is not available at block 1804, then the method 1800 proceeds to block 1808 to perform the write request on a second storage block of a second storage device. The second storage block may be identified based on, for example, the methods of FIG. 7. Then, at block 1810, the first storage block is marked as “to be erased,” and at block 1812, the second storage block is marked as “contains data.” At a later time, when the first storage device is not busy, the first storage block may be erased and marked as “available for data.”

When the file system handles write requests and tracks storage blocks on storage devices as described above, wear may be reduced on a set of solid state storage devices when replicating files. One technique for replicating files in a file system is mirroring drives, such as specified by redundant array of independent disks (RAID) level 1. When drives are mirrored, two (or more) devices may have block-for-block duplicates. Conventionally, when a write occurs to one device the same write is repeated synchronously to the second device.

The wear characteristics of the pair of devices configured for mirroring are identical because each device undergoes the same write requests in the same blocks on the storage device. Thus, both storage devices wear out and become unstable at similar times, which jeopardizes the integrity of both copies of the data. In the worst case, both devices fail at nearly the same time the resilient data is lost because both mirror copies are lost.

Instead, the file replication may be handled by the file system. The file system may manage each copy of the file independently of the other copies of the file. Each copy of the file may be placed on different devices, but because each file block is managed independently and each storage block is managed independently, wear due to mirroring of the data is distributed over storage blocks and storage devices.

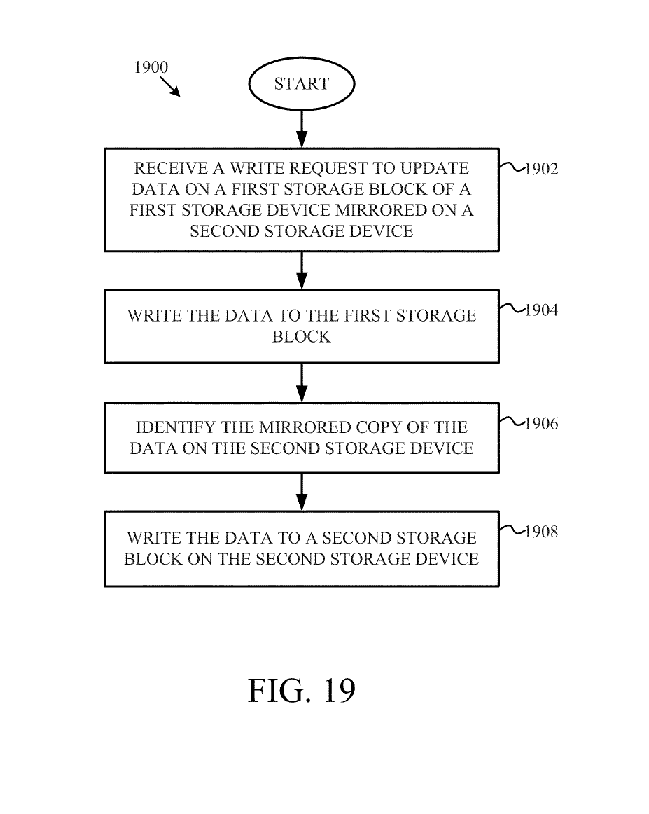

FIG. 19 is a flow chart illustrating management of mirrored drives by a file system according to one embodiment of the disclosure. A method 1900 begins at block 1902 with receiving a write request to update data on a first storage block of a first storage device mirrored on a second storage device. At block 1904, the data is written to the first storage block. At block 1906, the mirrored copy of the data is identified, such as on a second storage device. At block 1908, the data is written to the second storage block on the second storage device. The data may be written to an identical storage block on the second storage device as the first storage device or the data may be written to a different storage block. Furthermore, the data from the first storage device may be mirrored on other storage devices different from the second storage device.

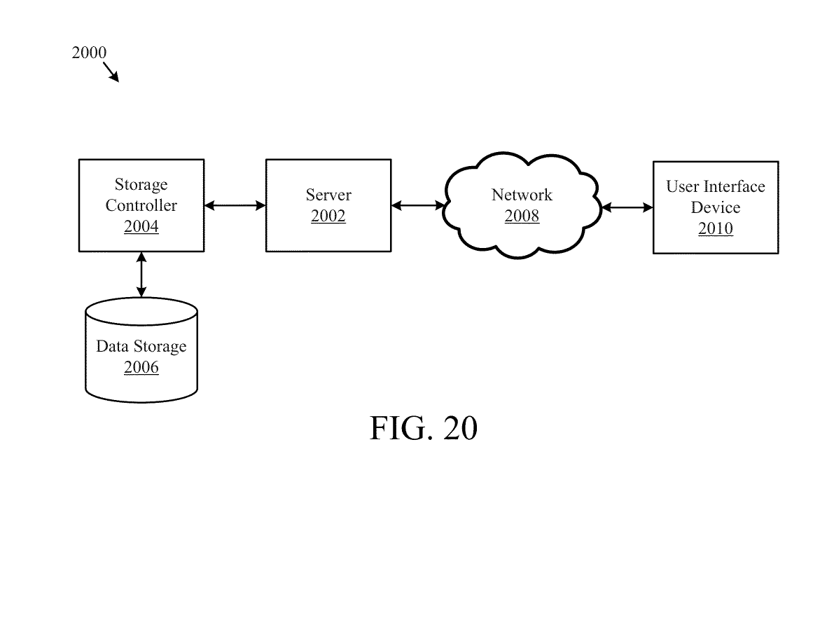

FIG. 20 illustrates one embodiment of a system 2000 for an information system, including a system for storing data in a storage device. The system 2000 may include a server 2002, a data storage device 2006, a network 2008, and a user interface device 2010. In a further embodiment, the system 2000 may include a storage controller 2004, or storage server configured to manage data communications between the data storage device 2006 and the server 2002 or other components in communication with the network 2008. In an alternative embodiment, the storage controller 2004 may be coupled to the network 2008.

In one embodiment, the user interface device 2010 is referred to broadly and is intended to encompass a suitable processor-based device such as a desktop computer, a laptop computer, a personal digital assistant (PDA) or tablet computer, a smartphone or other a mobile communication device having access to the network 2008. In a further embodiment, the user interface device 2010 may access the Internet or other wide area or local area network to access a web application or web service hosted by the server 2002 and may provide a user interface for enabling a user to enter or receive information, such as modifying policies.

The network 2008 may facilitate communications of data between the server 2002 and the user interface device 2010. The network 2008 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

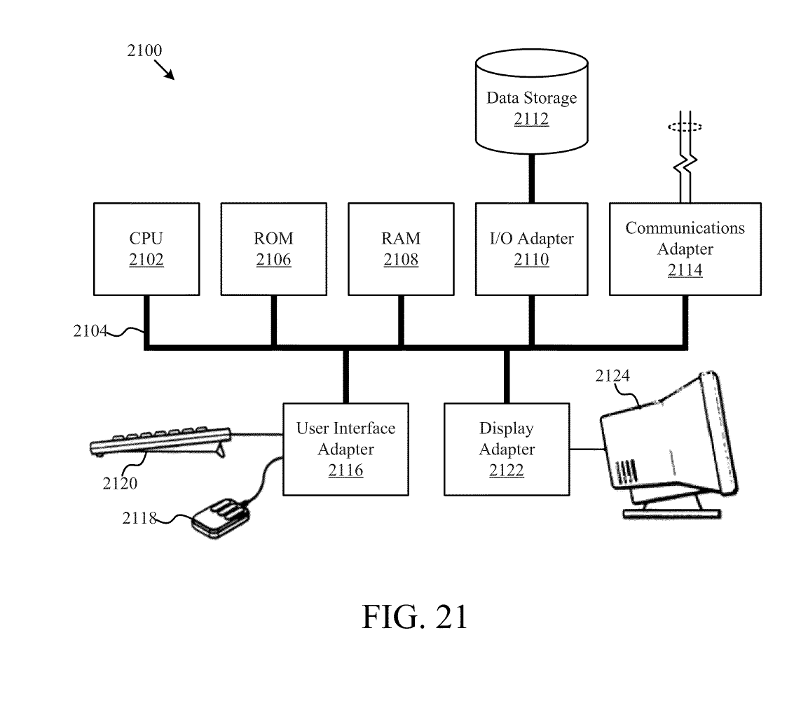

FIG. 21 illustrates a computer system 2100 adapted according to certain embodiments of the server 2002 and/or the user interface device 2010. The central processing unit (“CPU”) 2102 is coupled to the system bus 2104. The CPU 2102 may be a general purpose CPU or microprocessor, graphics processing unit (“GPU”), and/or microcontroller. The present embodiments are not restricted by the architecture of the CPU 2102 so long as the CPU 2102, whether directly or indirectly, supports the operations as described herein. The CPU 2102 may execute the various logical instructions according to the present embodiments.

The computer system 2100 also may include random access memory (RAM) 2108, which may be synchronous RAM (SRAM), dynamic RAM (DRAM), synchronous dynamic RAM (SDRAM), or the like. The computer system 2100 may utilize RAM 2108 to store the various data structures used by a software application. The computer system 2100 may also include read only memory (ROM) 2106 which may be PROM, EPROM, EEPROM, optical storage, or the like. The ROM may store configuration information for booting the computer system 2100. The RAM 2108 and the ROM 2106 hold user and system data, and both the RAM 2108 and the ROM 2106 may be randomly accessed.

The computer system 2100 may also include an input/output (1/O) adapter 2110, a communications adapter 2114, a user interface adapter 2116, and a display adapter 2122. The I/O adapter 2110 and/or the user interface adapter 2116 may, in certain embodiments, enable a user to interact with the computer system 2100. In a further embodiment, the display adapter 2122 may display a graphical user interface (GUI) associated with a software or web-based application on a display device 2124, such as a monitor or touch screen.

The I/O adapter 2110 may couple one or more storage devices 2112, such as one or more of a hard drive, a solid state storage device, a flash drive, a compact disc (CD) drive, a floppy disk drive, and a tape drive, to the computer system 2100. According to one embodiment, the data storage 2112 may be a separate server coupled to the computer system 2100 through a network connection to the I/O adapter 2110. The communications adapter 2114 may be adapted to couple the computer system 2100 to the network 2008, which may be one or more of a LAN, WAN, and/or the Internet. The user interface adapter 2116 couples user input devices, such as a keyboard 2120, a pointing device 2118, and/or a touch screen (not shown) to the computer system 2100. The keyboard 2120 may be an on-screen keyboard displayed on a touch panel. The display adapter 2122 may be driven by the CPU 2102 to control the display on the display device 2124. Any of the devices 2102-2122 may be physical and/or logical.

The applications of the present disclosure are not limited to the architecture of computer system 2100. Rather the computer system 2100 is provided as an example of one type of computing device that may be adapted to perform the functions of the server 2002 and/or the user interface device 2010. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 2100 may be virtualized for access by multiple users and/or applications.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM. CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving first data corresponding to an update of at least one file block;
identifying, by the file system, a storage block corresponding to the at least one file block;
writing the first data to a first storage block of a storage device.

2. The method of claim 1, in which the step of receiving first data comprises receiving first data corresponding to an update of a first file block, the method further comprising:
receiving second data corresponding to an update of a second file block also stored in the first storage block;
writing the first data and the second data to a first storage block of a storage device.

3. The method of claim 2, in which a size of the file block is smaller than a size of the storage block.

4. The method of claim 3, further comprising:
receiving third data corresponding to a partial update of a third file block also stored in the first storage block; and
writing the second data to the first storage block concurrently with the writing of the first data to the first storage block.

5. The method of claim 1, in which the first data corresponds to an update of a portion of a first file block when the first file block spans the first storage block and a second storage block.

6. The method of claim 5, in which a size of the file block is larger than a size of the storage block.

7. The method of claim 1, in which the storage device is a solid state storage device.

8. A computer program product, comprising:
a non-transitory computer-readable medium comprising:
code to receive first data corresponding to an update of at least one file block;
code to identify, by the file system, a storage block corresponding to the at least one file block;
code to write the first data to a first storage block of a storage device.

9. The computer program product of claim 8, in which the medium further comprises:
code to receive first data corresponding to an update of a first file block;
code to receive second data corresponding to an update of a second file block also stored in the first storage block;
code to write the first data and the second data to a first storage block of a storage device.

10. The computer program product of claim 9, in which a size of the file block is smaller than a size of the storage block.

11. The computer program product of claim 10, in which the medium further comprises:
code to receive third data corresponding to a partial update of a third file block also stored in the first storage block; and
code to write the third data to the first storage block concurrently with the writing of the first and second data to the first storage block.

12. The computer program product of claim 8, in which the first data corresponds to an update of a portion of a first file block when the first file block spans the first storage block and a second storage block.

13. The computer program product of claim 12, in which a size of the file block is larger than a size of the storage block.

14. An apparatus, comprising:
a memory;
a plurality of storage devices; and
a processor coupled to the memory and the plurality of storage devices, in which the processor is configured:
to receive first data corresponding to an update of at least one file block;
to identify, by the file system, a storage block corresponding to the at least one file block; and
to write the first data to a first storage block of a storage device.

15. The apparatus of claim 14, in which the processor is further configured:
to receive first data corresponding to an update of a first file block;
to receive second data corresponding to an update of a second file block also stored in the first storage block;
to write the first data and the second data to a first storage block of a storage device.

16. The apparatus of claim 15, in which a size of the file block is smaller than a size of the storage block.

17. The apparatus of claim 16, in which the processor is further configured:
to receive third data corresponding to a partial update of a second file block also stored in the first storage block; and
to write the third data to the first storage block concurrently with the writing of the first and second data to the first storage block.

18. The apparatus of claim 14, in which the first data corresponds to an update of a portion of a first file block when the first file block spans the first storage block and a second storage block.

19. The apparatus of claim 18, in which a size of the file block is larger than a size of the storage block.

20. The apparatus of claim 14, in which the plurality of storage devices comprise a plurality of solid state devices (SSDs).
